(19) United States
(12) Patent Application Publication
(10) Pub. No.: US 2018/0171235 A1
(43) Pub. Date: Jun. 21, 2018

(54) LIQUID CRYSTAL MEDIUM MIXTURE AND LIQUID CRYSTAL DISPLAY PANEL

(71) Applicant: Shenzhen China Star Optoelectronics Technology Co., Ltd., Shenzhen, Guangdong (CN)

(72) Inventor: Xingwu CHEN, Shenzhen, Guangdong (CN)

(73) Assignee: Shenzhen China Star Optoelectronics Technology Co. , Ltd., Shenzhen, Guangdong (CN)

(21) Appl. No.: 15/303,086

(22) PCT Filed: Sep. 14, 2016
(86) PCT No.: PCT/CN2016/098937

§ 371 Date: Oct. 10, 2016

(30) Foreign Application Priority Data
Aug. 10, 2016 (CN) 2016106542578

(51) Int. Cl. C09K 19/54; C09K 19/30; C08F 22/20; G02F 1/1334

(52) U.S. Cl. CPC C09K 19/542; C09K 19/3066; G02F 2001/13345; G02F 1/1334; C09K 2019/546; C08F 22/20

(57) ABSTRACT

The invention provides a liquid crystal medium mixture including a liquid crystal material and at least one kind of polymerizable monomer capable of undergoing polymerization reaction under ultraviolet light irradiation. Under an irradiation of a first ultraviolet light, the polymerizable monomer forms a partition in the liquid crystal display panel by polymerization reaction and thereby restricts a flow of the liquid crystal material. The invention further provides a liquid crystal display panel.

### TECHNICAL FIELD

The invention relates to the field of display technology, and more particularly to a liquid crystal medium mixture and a liquid crystal display panel.

### DESCRIPTION OF RELATED ART

The flexible display technology is one of the most active research directions in recent years in the field of electronic information and meanwhile also is one of important directions for the development of future electronic information industry. Flexible displays include a flexible thin film transistor liquid crystal display device (Flexible TFT-LCD), a flexible organic light emitting display device (Flexible OLED) and so on, which have characteristics such as lightweight, bendable, foldable and even rollable and generally are applied for mobile phones, electronic papers and so on.

For the flexible thin film transistor liquid crystal display device, a liquid crystal material is necessarily employed. The liquid crystal material itself has flowability, but in the case of substrates being bent, an uneven pressure would cause a flow of the liquid crystal material and thereby cause problems such as poor alignment of the liquid crystal material and light leakage. In order to restrict the flow of the liquid crystal material during being bent, it is feasible to form a partition between the substrates so as to solve the problem of the liquid crystal flowability in the case of the substrates being bent. Therefore, how to achieve a partition in the interior of the substrates to restrict the flow of the liquid crystal material is a key of realizing the flexible thin film transistor liquid crystal display technology.

### SUMMARY

Accordingly, a technical problem mainly to be solved by the invention is to provide a liquid crystal medium mixture capable of restricting a flow of a liquid crystal material.

In order to solve the technical problem, a technical solution provided by the invention is to provide a liquid crystal medium mixture. The liquid crystal medium mixture includes a liquid crystal material and at least one kind of polymerizable monomer (also termed as reactive monomer) capable of undergoing polymerization reactions under ultraviolet light irradiation. Under an irradiation of a first ultraviolet light, the polymerizable monomer forms a partition in a liquid crystal display panel by polymerization reaction and thereby restricts a flow of the liquid crystal material. Under an irradiation of a second ultraviolet light, the polymerizable monomer forms a polymer network in the liquid crystal material by polymerization reaction and thereby restricts an alignment of the liquid crystal material. A mass of the polymerizable monomer is 1%-40% of a total mass of the liquid crystal medium mixture.

In an embodiment, the polymerizable monomer includes at least one of acrylate, acrylate derivative, methacrylate, methacrylate derivative, styrene, styrene derivative, epoxy resin and aliphatic amine epoxy resin.

In an embodiment, a structure of the polymerizable monomer is

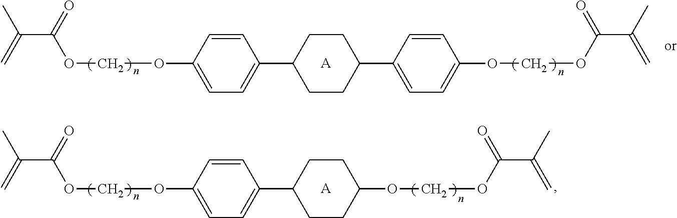

where n is in the range of 1-7 and A is one selected from a group consisting of benzene, benzyl, fluorobenzene, para-ethyl benzene, para-propylbenzene and para-methanoic phenyl ester.

In an embodiment, the liquid crystal medium mixture further includes a photoinitiator. A mass of the photoinitiator is 0.02%-0.07% of a total mass of the liquid crystal medium mixture.

In order to solve the technical problem, another technical solution provided by the invention is to provide a liquid crystal medium mixture. The liquid crystal medium mixture includes a liquid crystal material and at least one kind of polymerizable monomer capable of undergoing polymerization reaction under ultraviolet light irradiation. Under an irradiation of a first ultraviolet light, the polymerizable monomer forms a partition in the liquid crystal display panel by polymerization reaction and thereby restricts a flow of the liquid crystal material.

In an embodiment, under irradiation of a second ultraviolet light, the polymerizable monomer forms a polymer network in the liquid crystal material by polymerization reaction and thereby restricts an alignment of the liquid crystal material.

In an embodiment, the polymerizable monomer includes at least one of acrylate, acrylate derivative, methacrylate, methacrylate derivative, styrene, styrene derivative, epoxy resin and aliphatic amine epoxy resin.

In an embodiment, a structure of the polymerizable monomer is

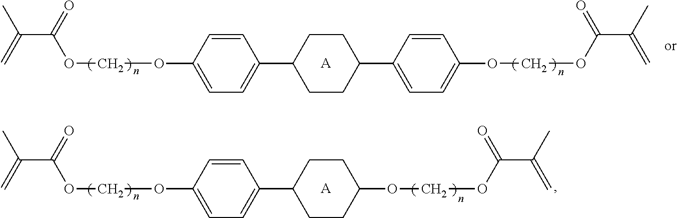

where n is in the range of 1-7 and A is one of benzene, benzyl, fluorobenzene, para-ethyl benzene, para-propyl benzene and para-methanoic phenyl ester.

In an embodiment, a mass of the polymerizable monomer is 1%-40% of a total mass of the liquid crystal medium mixture.

In an embodiment, the liquid crystal medium mixture further includes a photoinitiator. A mass of the photoinitiator is 0.02%-0.07% of a total mass of the liquid crystal medium mixture.

In order to solve the above technical problem, still another technical solution provided by the invention is to provide a liquid crystal display panel. The liquid crystal display panel includes oppositely disposed a first substrate and a second substrate, and a liquid medium mixture disposed between the first substrate and the second substrate. The liquid crystal medium mixture includes a liquid crystal material and at least one kind of polymerizable monomer capable of undergoing polymerization reaction under ultraviolet light irradiation. The polymerizable monomer forms a partition in the liquid crystal display panel by polymerization reaction under an irradiation of a first ultraviolet light and thereby restricts a flow of the liquid crystal material.

In an embodiment, the polymerizable monomer forms a polymer network in the liquid crystal material by polymerization reaction under an irradiation of a second ultraviolet light and thereby restricts an alignment of the liquid crystal material.

In an embodiment, a mass of the polymerizable monomer is for 1%-40% of a total mass of the liquid crystal medium mixture.

In an embodiment, the liquid crystal medium mixture further includes a photoinitiator. A mass of the photoinitiator is 0.02%-0.07% of a total mass of the liquid crystal medium mixture.

In an embodiment, the polymerizable monomer includes at least one of acrylate, acrylate derivative, methacrylate, methacrylate derivative, styrene, styrene derivative, epoxy resin and aliphatic amine epoxy resin.

In an embodiment, a structure of the polymerizable monomer is

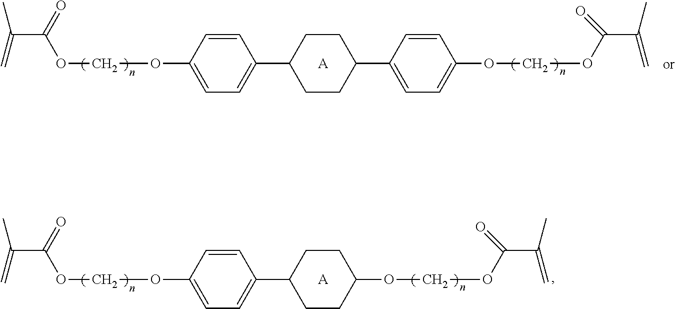

where n is in the range of 1-7 and A is one of benzene, benzyl, fluorobenzene, para-ethyl benzene, para-propyl benzene and para-methanoic phenyl ester.

Efficacy of the invention is that: different from the prior art, the polymerizable monomer in the liquid crystal medium mixture can undergo polymerization reaction to form a partition under irradiation of a first ultraviolet light, therefore can effectively restrict the flow of the liquid crystal material and effectively avoid the phenomenon such as poor alignment and light leakage occurred when the panel is bent.

### BRIEF DESCRIPTION OF THE DRAWINGS

FIG. 1 is a schematic cross-sectional view of a liquid crystal display panel according to an embodiment of the invention.

FIG. 2 shows a manufacturing process of substrates in a manufacturing process of the liquid crystal display panel according to the invention.

FIG. 3 shows a process of a liquid crystal medium mixture being added between the substrates in the manufacturing process of the liquid crystal display panel according to the invention.

FIG. 4 shows a process of forming partitions in a first method in a manufacturing process of the liquid crystal display panel according to the invention.

FIG. 5 shows a process of forming a polymer network in the first method in a manufacturing process of the liquid crystal display panel according to the invention.

FIG. 6 shows a process of forming partitions and a polymer networks simultaneously in a second method in a manufacturing process of the liquid crystal display panel according to the invention.

### DETAILED DESCRIPTION OF EMBODIMENTS

In the following, detailed description of the invention will be made with references to embodiments and accompanying drawings.

The invention provides a liquid crystal medium mixture applied for a liquid crystal display panel. The liquid crystal medium mixture includes a liquid crystal material, a photoinitiator and at least one kind of polymerizable monomer capable of undergoing polymerization reaction under ultraviolet light irradiation.

The liquid crystal material is a nematic liquid crystal material and has a negative dielectric anisotropy constant. For example, it is one of

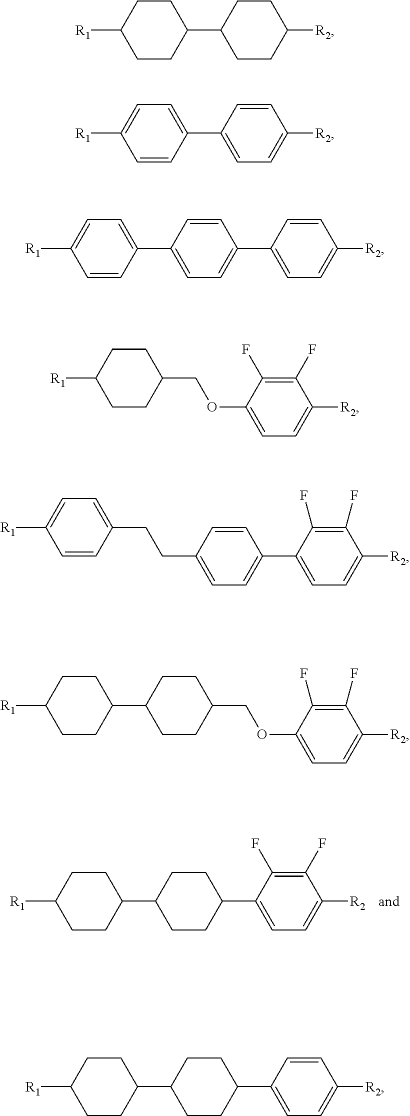

where R1 and R2 each are an alkyl chain, e.g., CₙH₂ₙ₊₁, OCₙH₂₊₁, CₙH₂ₙ, OCₙH₂ₙ and the like.

In other embodiment, a structural formula of the liquid crystal material is at least one of

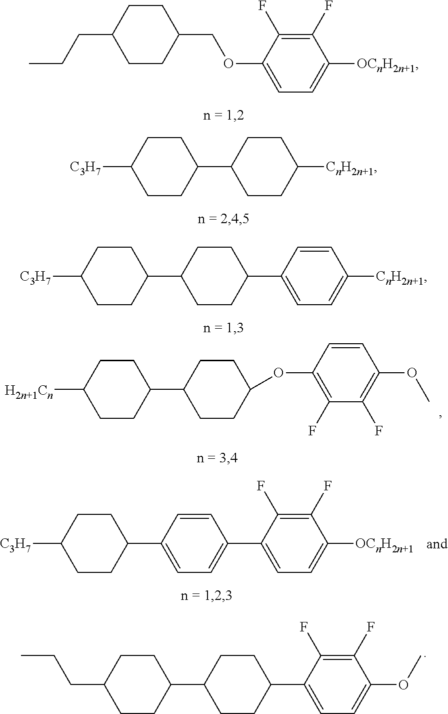

A material of the photoinitiator may be but not limited to a commercial photoinitiator, such as

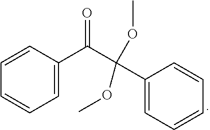 [SMILES: COC(OC)(C(=O)c1ccccc1)c1ccccc1]

A mass of the photoinitiator is 0.02%-0.07% of a total mass of the liquid crystal medium mixture, e.g., 0.02, 0.05, 0.07 and the like.

When the polymerizable monomer is irradiated by a first ultraviolet light, the polymerizable monomer undergoes a polymerization reaction to form partitions in the liquid crystal display panel and thereby restrict a flow of the liquid crystal material. When the polymerizable monomer is irradiated by a second ultraviolet light, the polymerizable monomer undergoes a polymerization reaction to form a polymer network in the liquid crystal material and thereby restrict an alignment of the liquid crystal material. It should be understood that a light intensity of the first ultraviolet light is greater than that of the second ultraviolet light.

It should be understood that, when the first ultraviolet light is used for irradiation, most of the polymerizable monomer in the liquid crystal medium mixture gets together to undergo polymerization reaction and thereby form partitions. A small part of the polymerizable monomer disperses in the liquid crystal material and photoinitiator and undergoes polymerization reaction when being irradiated by the second ultraviolet light to form a polymer network.

The polymerizable monomer includes at least one of acrylate, acrylate derivative, methacrylate, methacrylate derivative, styrene, styrene derivative, epoxy resin and aliphatic amine epoxy resin.

It should be understood that the polymerizable monomer may further include one of benzene, benzyl, fluorobenzene, para-ethyl benzene, para-propyl benzene and para-methanoic phenyl ester.

For example, a structure of the polymerizable monomer is

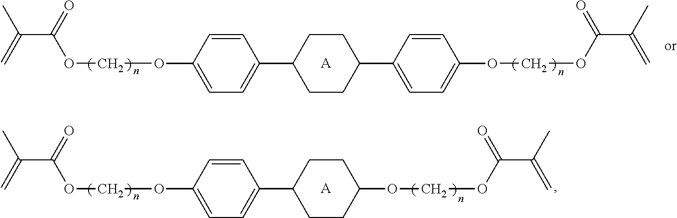

where n is in the range of 1-7 and A is one of benzene, benzyl, fluorobenzene, para-ethyl benzene, para-propyl benzene and para-methanoic phenyl ester.

In a concrete embodiment, a structure of the polymerizable monomer is

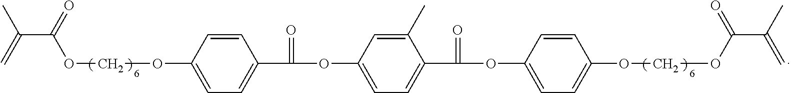

It should be understood that because of its long molecular structure, it is easy to form a polymer network structure during a curing reaction.

A mass of the polymerizable monomer is 1%-40% of a total mass of the liquid crystal medium mixture, e.g., 1%, 10%, 20%, 30%, 40% and the like.

Different from the prior art, the polymerizable monomer in the liquid crystal medium mixture provided by the invention can undergo polymerization reaction to form partitions under the first ultraviolet light irradiation and thereby effectively restrict the flow of the liquid crystal material as well as effectively avoid the phenomenon e.g. poor alignment and light leakage occurred when the panel is bent. In addition, under the irradiation of the second ultraviolet light, the polymerizable monomer undergoes polymerization reaction to form a polymer network in the liquid crystal material and thereby restrict an alignment of the liquid crystal material. The polymer network also can increase a mouding force, so as to realize a fast-response flexible display or curved surface display.

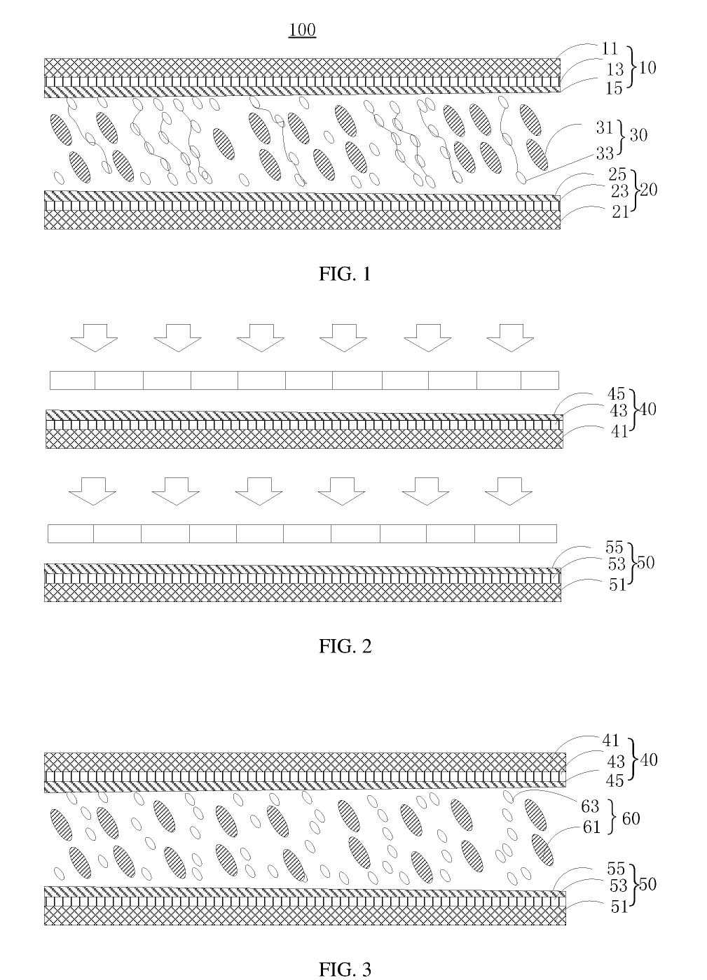

Please refer to FIG. 1, the invention also provides a liquid crystal display panel 100 including: oppositely disposed a first substrate 10 and a second substrate 20, and further a liquid crystal medium mixture 30 disposed between the first substrate 10 and the second substrate 20.

It should be understood that the first substrate 10 and the second substrate 20 each may be a glass substrate or a flexible substrate. In the illustrated embodiment, the first substrate 10 and the second substrate 20 are flexible substrates.

The first substrate 10 includes a first base 11, a first electrode 13 and a first alignment layer 15 sequentially formed in that order. The alignment layer 15 is a vertical alignment layer.

The second substrate 20 includes a second base 21, a second electrode 23 and a second alignment layer 25 sequentially formed in that order. The second alignment layer 25 is a vertical alignment layer.

Furthermore, both of the first alignment layer 15 and the second alignment layer 25 are each a photoalignment layer. When a polarized ultraviolet light is used to irradiate the photoalignment layer, a certain pretilt angle would be formed, which makes consistency of rotational directions of the liquid crystal material be better.

It should be understood that, when disposing the first substrate 10 and the second substrate 20, the first alignment layer 15 and the second alignment layer 25 are disposed close to ((i.e., facing toward)) each other, and the first base 11 and the second base 21 are disposed facing away from each other.

The liquid crystal medium mixture 30 includes a liquid crystal material 31, a photoinitiator (not shown) and at least one kind of polymerizable monomer 33 capable of undergoing polymerization reaction under ultraviolet light irradiation.

The liquid crystal material 31 is a nematic liquid crystal material and has a negative dielectric anisotropy constant. For example, it is one of

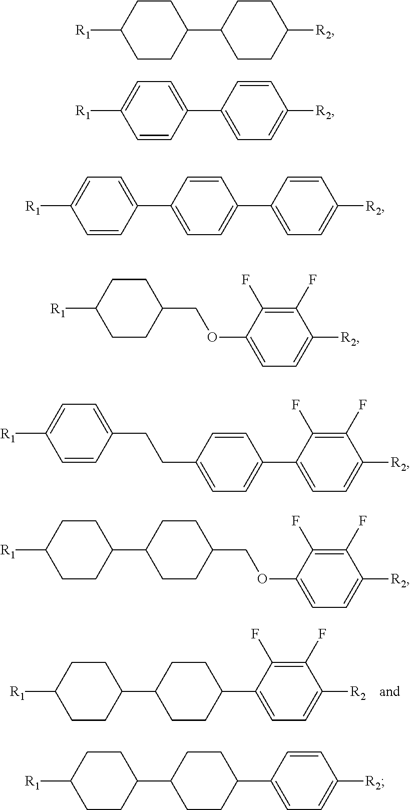

where R1 and R2 each are an alkyl chain, for example CₙH₂ₙ₊₁, OCₙH₂₊₁, CₙH₂ₙ, OCₙH₂ₙ and the like.

In other embodiment, a structural formula of the liquid crystal material 31 is at least one of

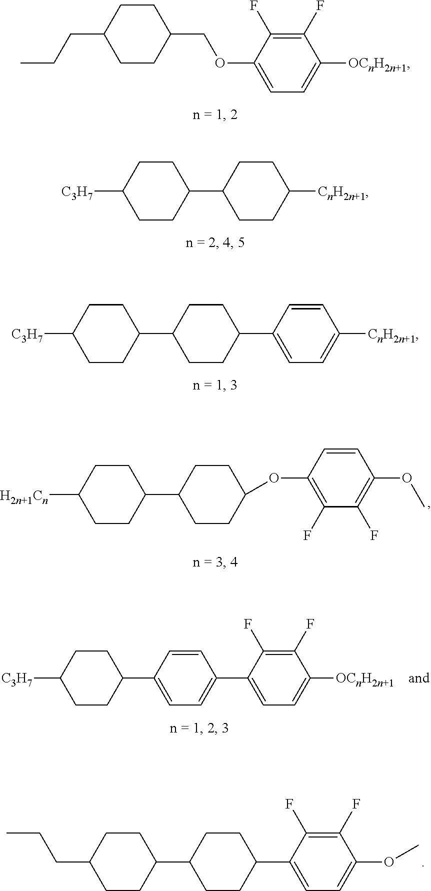

A material of the photoinitiator may be but not limited to a commercial photoinitiator such as

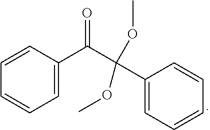 [SMILES: COC(OC)(C(=O)c1ccccc1)c1ccccc1]

A mass of the photoinitiator is 0.02%-0.07% of a total mass of the liquid crystal medium mixture, e.g., 0.02, 0.05, 0.07 and the like.

When the polymerizable monomer 33 is irradiated by a first ultraviolet light, the polymerizable monomer 33 undergoes a polymerization reaction to form partitions in the liquid crystal display panel and thereby restrict a flow of the liquid crystal material. When the polymerizable monomer 33 is irradiated by a second ultraviolet light, the polymerizable monomer undergoes a polymerization reaction to form a polymer network in the liquid crystal material and thereby restrict an alignment of the liquid crystal material. It should be understood that a light intensity of the first ultraviolet light is greater than that of the second ultraviolet light.

It should be understood that, under a first ultraviolet light irradiation, most of the polymerizable monomer 33 in the liquid crystal medium mixture 30 gets together to undergo polymerization reaction and thereby form partitions, and a small part of the polymerizable monomer 33 disperses in the liquid crystal material 31 and the photoinitiator, which forms a polymer network by polymerization reaction under the second ultraviolet light irradiation.

The polymerizable monomer 33 includes at least one of acrylate, acrylate derivative, methacrylate, methacrylate derivative, styrene, styrene derivative, epoxy resin and aliphatic amine epoxy resin.

It can be understood that the polymerizable monomer 33 may further include at least one of benzene, benzyl, fluorobenzene, para-ethyl benzene, para-propyl benzene and para-methanoic phenyl ester.

For example, a structure of the polymerizable monomer 33 is

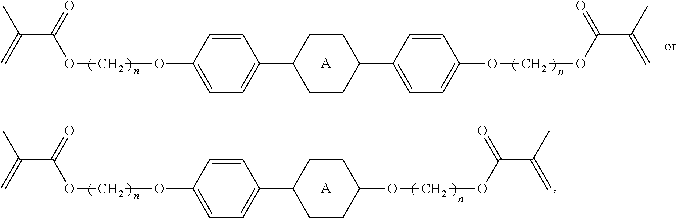

where n is in the range of 1-7 and A is one of benzene, benzyl, fluorobenzene, para-ethyl benzene, para-propyl benzene and para-methanoic phenyl ester.

In a concrete embodiment, a structure of the polymerizable monomer 33 is

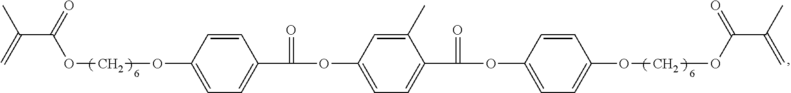

it should be understood that, because of its long molecular structure, it is easy to form the polymer network structure during a curing reaction.

A mass of the polymerizable monomer 33 is 1%-40% of a total mass of the liquid crystal medium mixture 30, e.g., 1%, 10%, 20%, 30%, 40% and the like.

The polymerizable monomer 33 in the liquid crystal medium mixture of the liquid crystal display panel 100 provided in the invention can undergo polymerization reaction to form partitions under the first ultraviolet light irradiation, and therefore can effectively restrict the flow of the liquid crystal material 31 as well as effectively avoid the phenomenon of poor alignment and light leakage occurred when the liquid crystal display panel 100 is bent. In addition, under a second ultraviolet light irradiation, the polymerizable monomer 33 can undergo polymerization reaction to form a polymer network in the liquid crystal material, and therefore can restrict an alignment of the liquid crystal material 31. The polymer network further can increase a mouding force to realize a fast-response flexible display or curved surface display.

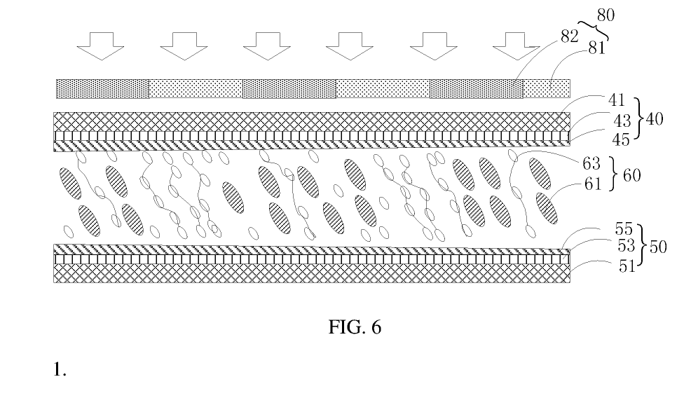

Please refer to FIG. 2 to FIG. 6 together, a manufacturing method of a liquid crystal display panel is further provided by the invention. The manufacturing method includes following steps.

Step S101: two substrates are provided as a first substrate 40 and a second substrate 50 respectively.

In particular, a first base 41 and a second base 51 are provided. A first electrode 43 and a first alignment layer 45 are sequentially formed on the first base 41 in that order. A second electrode 53 and a second alignment layer 55 are sequentially formed on the second base 51 in that order.

The first alignment layer 45 and the second alignment layer 55 are vertical alignment layers. Furthermore, the first alignment layer 45 and the second alignment layer 55 are photoalignment layers.

It should be understood that, please refer to FIG. 2, when the photoalignment layers are irradiated by polarized ultraviolet light, the photoalignment layers each form a certain pretilt angle, so that the consistency of rotational directions of a liquid crystal material in a manufactured liquid crystal display panel is better.

Step S102, a liquid crystal medium mixture 60 is prepared in particular, a liquid crystal material 61 and at least one kind of polymerizable monomer 63 capable of undergoing polymerization reaction under ultraviolet light irradiation are mixed, heated and stirred and further filtered, the liquid crystal medium mixture 60 is prepared as a result.

It should be understood that impurities in raw materials could be filtered out by filtering.

The polymerizable monomer 63 includes at least one of acrylate, acrylate derivative, methacrylate, methacrylate derivative, styrene, styrene derivative, epoxy resin and aliphatic amine epoxy resin.

It should be understood that the polymerizable monomer 63 further includes one of benzene, benzyl, fluorobenzene, para-ethyl benzene, para-propyl benzene and para-methanoic phenyl ester.

For example, a structure of the polymerizable monomer 63 is

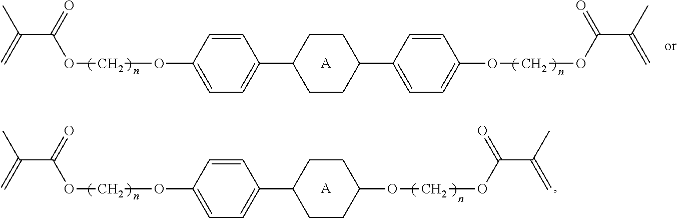

where n is in the range of 1-7 and A is one of benzene, benzyl, fluorobenzene, para-ethyl benzene, para-propyl benzene and para-methanoic phenyl ester.

In a concrete embodiment, a structure of the polymerizable monomer 63 is

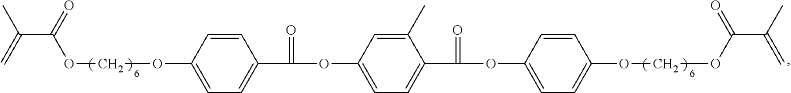

it should be understood that, because of its long molecular structure, it is easy to form the polymer network structure during a curing reaction.

A mass of the polymerizable monomer 63 is 1%-40% of a total mass of the liquid crystal medium mixture, e.g., 1%, 10%, 20%, 30%, 40% and the like.

It should be understood that the liquid crystal medium mixture 60 further includes a photoinitiator. A mass of the photoinitiator is 0.02%-0.07% of a total mass of the liquid crystal medium mixture, e.g., 0.02, 0.05, 0.07 and the like.

Step S103, please refer to FIG. 3, the liquid crystal medium mixture 60 is dripped onto one of the first substrate 40 and the second substrate 50, and then the other substrate is disposed covering on the liquid crystal medium mixture 60, so that the liquid crystal medium mixture 60 is fit between the first substrate 40 and the second substrate 50.

Step S104, one of the first substrate 40 and the second substrate 50 is irradiated by a first ultraviolet light and a second ultraviolet light in an order, so that the polymerizable monomer 63 in the liquid crystal medium mixture forms partitions and a polymer network to restrict a flow and an alignment of the liquid crystal material respectively.

Regarding one of the first substrate 40 and the second substrate 50 is irradiated by a first ultraviolet light and a second ultraviolet light in an order so that the polymerizable monomer 63 in the liquid crystal medium mixture forms partitions and a polymer network to restrict a flow and an alignment of the liquid crystal material respectively, it can be realized by the following two methods.

A first method includes the following steps:

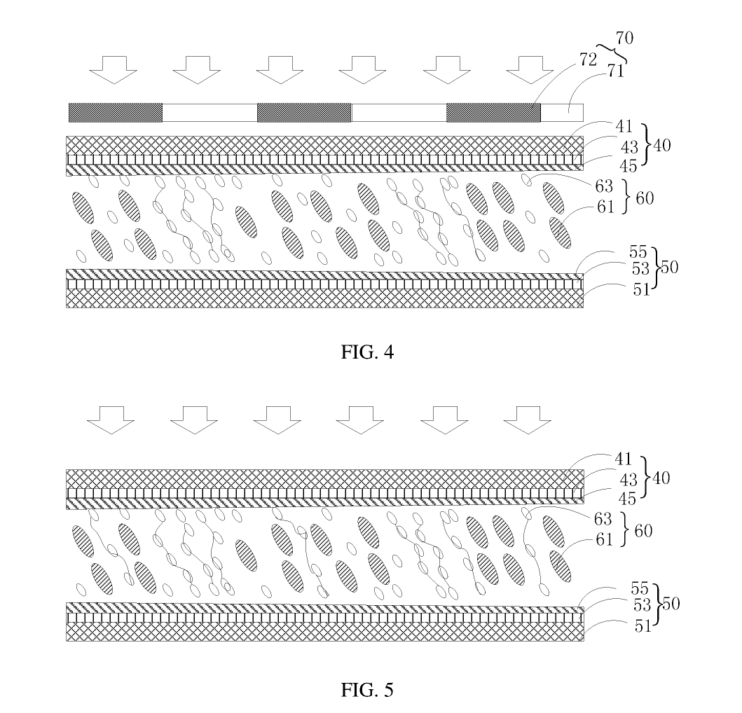

Please refer to FIG. 4, a mask layer 70 is disposed covering a surface of one of the first substrate 40 and the second substrate 50 facing away the liquid crystal medium mixture 60. The mask layer 70 includes a light transmissive region 71 and a light blocking region 72 alternately arranged.

When the first time ultraviolet light irradiation is carried out, the polymerizable monomer 63 corresponding to the light transmissive region 71 aggregate together under the ultraviolet light irradiation to undergo polymerization reaction and thereby is cured to form the partitions.

Afterwards, the mask layer 70 is removed.

Please refer to FIG. 5, when the second time ultraviolet light irradiation is carried out, the polymerizable monomer 63 between two adjacent partitions undergoes polymerization reaction and then is cured to form the polymer network.

It should be understood that, in the first method, a first ultraviolet light is defined as a sum of an intensity of the first time ultraviolet light irradiation and an intensity of the second time ultraviolet light irradiation, and a second ultraviolet light is defined as the intensity of the second time ultraviolet light irradiation.

It should be understood that, when the first time ultraviolet light irradiation is carried out, energy of the used ultraviolet at 365 nm has an intensity range 60-100 mW/cm², e.g., 60 mW/cm², 80 mW/cm², 100 mW/cm² and the like; or the intensity range at 313 nm is 0.1-1 mW/cm², e.g., 0.1 mW/cm², 0.5 mW/cm², 1mW/cm² and the like; an irradiation time is 1 min-120min.

A second method includes the following steps:

A grayscale mask layer 80 is disposed covering a surface of one of the first substrate 40 and the second substrate 50 facing away from the liquid crystal medium mixture 60. The grayscale mask layer 80 includes a first light transmissive region 81 and a second light transmissive region 82, and light transmittances of the first light transmissive region 81 and the second light transmissive region 82 are different. In the illustrated embodiment, the light transmittance of the first light transmissive region 81 is larger than that of the second light transmissive region 82.

Under an ultraviolet light irradiation, the polymerizable monomer 63 corresponding to the first light transmissive region 81 undergoes a polymerization reaction under the ultraviolet light irradiation and thereby is cured to form partitions; and the polymerizable monomer 63 corresponding to the second light transmissive region 82 is cured to form a polymer network.

It should be understood that, in the second method, a first ultraviolet light is defined as an irradiation intensity corresponding to the first light transmissive region 81, and a second ultraviolet light is defined as an irradiation intensity corresponding to the second light transmissive region 82.

It should be understood that, because of the light transmittances of the first light transmissive region 81 and the second light transmissive region 82 being different, light volumes of the different regions under the ultraviolet light irradiation are different and therefore partitions and a polymer network respectively are formed in the different regions.

Different from the prior art, in the invention, the invention mixes the polymerizable monomer 63 and the liquid crystal material 61 to form the liquid crystal medium mixture 60 and then adds the liquid crystal medium mixture 60 between the first substrate 40 and the second substrate 50, by irradiation of the first ultraviolet light and the second ultraviolet light, the partitions and the polymer network are formed respectively so as to restrict the flow and the alignment of the liquid crystal material 61. Furthermore the polymer network also can increase a mouding force so as to realize a fast-response flexible display or curved surface display.

It should be understood that the foregoing discussion only is some embodiments of the invention, and therefore it is not limited to the protection scope of the invention, any equivalent structures or equivalent transformation of processes made based on the specification and the accompanying drawings of the invention, and directly or indirectly being used in other related technical fields, are similarly included within the protection scope of the invention.

What is claimed is:

1. A liquid crystal medium mixture comprising a liquid crystal material and at least one kind of polymerizable monomer capable of undergoing polymerization reaction under ultraviolet light irradiation;
wherein under irradiation of a first ultraviolet light, the polymerizable monomer forms a partition in a liquid crystal display panel by polymerization reaction and thereby restricts a flow of the liquid crystal material; and under irradiation of a second ultraviolet light, the polymerizable monomer forms a polymer network in the liquid crystal material by polymerization reaction and thereby restricts an alignment of the liquid crystal material; a mass of the polymerizable monomer is 1%-40% of a total mass of the liquid crystal medium mixture.

2. The liquid crystal medium mixture according to claim 1, wherein the polymerizable monomer comprises at least one selected from a group consisting of acrylate, acrylate derivative, methacrylate, methacrylate derivative, styrene, styrene derivative, epoxy resin and aliphatic amine epoxy resin.

3. The liquid crystal medium mixture according to claim 2, wherein a structure of the polymerizable monomer is 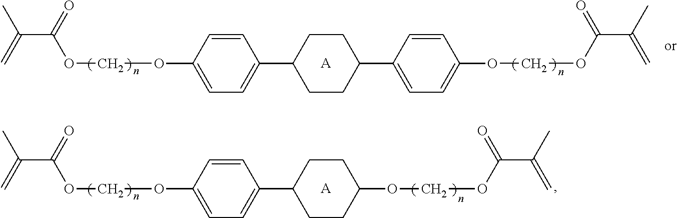
where n is in the range of 1-7, and A is one of benzene, benzyl, fluorobenzene, para-ethyl benzene, para-propyl benzene and para-methanoic phenyl ester.

4. The liquid crystal medium mixture according to claim 1, wherein the liquid crystal medium mixture further comprises a photoinitiator; a mass of the photoinitiator is 0.02%-0.07% of a total mass of the liquid crystal medium mixture.

5. A liquid crystal medium mixture comprising a liquid crystal material and at least one kind of polymerizable monomer capable of undergoing polymerization reaction under ultraviolet light irradiation;
wherein under irradiation of a first ultraviolet light, the polymerizable monomer forms a partition in the liquid crystal display panel by polymerization reaction and thereby restricts a flow of the liquid crystal material.

6. The liquid crystal medium mixture according to claim 5, wherein under irradiation of a second ultraviolet light, the polymerizable monomer forms a polymer network in the liquid crystal material by polymerization reaction and thereby restricts an alignment of the liquid crystal material.

7. The liquid crystal medium mixture according to claim 5, wherein the polymerizable monomer comprises at least one of acrylate, acrylate derivative, methacrylate, methacrylate derivative, styrene, styrene derivative, epoxy resin and aliphatic amine epoxy resin.

8. The liquid crystal medium mixture according to claim 7, wherein a structure of the polymerizable monomer is 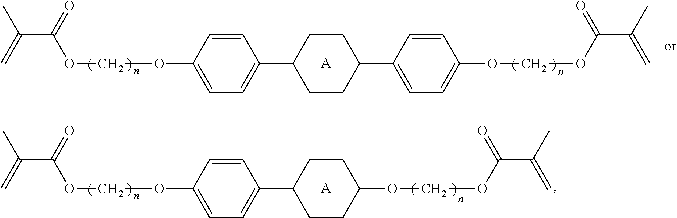
where n is in the range of 1-7, and A is one selected from a group consisting of benzene, benzyl, fluorobenzene, para-ethyl benzene, para-propyl benzene and para-methanoic phenyl ester.

9. The liquid crystal medium mixture according to claim 5, wherein a mass of the polymerizable monomer is 1%-40% of a total mass of the liquid crystal medium mixture.

10. The liquid crystal medium mixture according to claim 5, wherein the liquid crystal medium mixture further comprises a photoinitiator; a mass of the photoinitiator is 0.02%-0.07% of a total mass of the liquid crystal medium mixture.

11. A liquid crystal display panel comprising oppositely disposed a first substrate and a second substrate, and a liquid medium mixture disposed between the first substrate and the second substrate; the liquid crystal medium mixture comprising a liquid crystal material and at least one kind of polymerizable monomer capable of undergoing polymerization reaction under ultraviolet light irradiation;
wherein the polymerizable monomer forms a partition in the liquid crystal display panel by polymerization reaction under irradiation of a first ultraviolet light and thereby restricts a flow of the liquid crystal material.

12. The liquid crystal display panel according to claim 11, wherein the polymerizable monomer forms a polymer network in the liquid crystal material by polymerization reaction under irradiation of a second ultraviolet light and thereby restricts an alignment of the liquid crystal material.

13. The liquid crystal display panel according to claim 11, wherein a mass of the polymerizable monomer is 1%-40% of a total mass of the liquid crystal medium mixture.

14. The liquid crystal display panel according to claim 11, wherein the liquid crystal medium mixture further comprises a photoinitiator; a mass of the photoinitiator is 0.02%-0.07% of a total mass of the liquid crystal medium mixture.

15. The liquid crystal display panel according to claim 11, wherein the polymerizable monomer comprises at least one of acrylate, acrylate derivative, methacrylate, methacrylate derivative, styrene, styrene derivative, epoxy resin and aliphatic amine epoxy resin.

16. The liquid crystal display panel according to claim 11, wherein a structure of the polymerizable monomer is 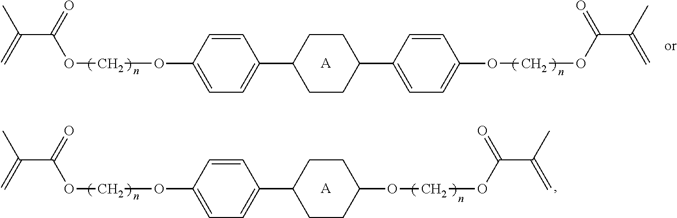
where n is in the range of 1-7 and A is one of benzene, benzyl, fluorobenzene, para-ethyl benzene, para-propylbenzene and para-methanoic phenyl ester.
